(19) United States
(12) Patent Application Publication
(10) Pub. No.: US 2019/0240753 A1
(43) Pub. Date: Aug. 8, 2019

(54) Method and apparatus for producing toothed blades

(71) Applicant: LIBERTY PERFORMANCE STEELS LIMITED, London Greater London (GB)

(72) Inventors: Carl Jukes, West Bromwich, West Midlands (GB); Michael Horan, West Bromwich, West Midlands (GB)

(21) Appl. No.: 16/341,957

(22) PCT Filed: Sep. 28, 2017
(86) PCT No.: PCT/GB2017/052911

§ 371 Date: Apr. 15, 2019

(30) Foreign Application Priority Data
Oct. 14, 2016 (GB) 1617474.0
Apr. 7, 2017 (GB) 1705690.4

(51) Int. Cl. B23D 65/02; B23D 61/12; B23K 26/00; B23K 26/38; B23K 26/40

(52) U.S. Cl. CPC B23D 65/02; B23D 61/121; B23D 65/04; B23K 26/38; B23K 26/40; B23K 26/0093

(57) ABSTRACT

A method (100) of producing toothed blades from a strip material (200, 250) is disclosed. The method (100) comprises: cutting the strip material using combined laser cutting (102a) and mechanical machining (104a) or using waterjet cutting (102b) to form a plurality of teeth in an edge of the strip material (200, 250), wherein the cutting is controlled to cut each of the teeth using a flexible programmable geometry. A toothed blade production line (300, 400) arranged to produce toothed blades from a strip material using the method is also disclosed.

The present invention relates to a method of producing toothed blades from a strip material and a toothed blade production line. In particular, the present invention relates to the manufacture of saw blades produced from a strip material (e.g. bi-metallic, carbon and carbide strip material), e.g. band-saw blades, hack saw blades, reciprocating saw blades, wood bandsaws, food bandsaws, and metal-cutting bandsaws.

Toothed blades used for band-saws, hack saws, reciprocating saws, holesaws, wood bandsaws, food bandsaws, metal-cutting bandsaws or the like generally comprise a length of strip material having a plurality of teeth cut into one edge. These types of saw require a generally straight length of toothed cutting material as opposed to circular saws which require a circular shaped saw blade with circumferential teeth.

It is a known manufacturing method to produce a band-saw blade by machining (e.g. milling/grinding) a number of teeth into the edge of a length of strip material. The machining process is slow and limits the speed at which saw blades can be produced from the resulting toothed length of strip material. In order to increase the rate of production of saw blades the strip material may be machined in batches. This is done by aligning a number (e.g. 40) of lengths of material side by side and machining the teeth on each length in the batch simultaneously.

While this method may improve the rate of saw blade production it has a number of drawbacks. The flexibility of tooth geometry provided by existing milling techniques is limited. If a batch of strips are milled simultaneously, a perpendicular cut angle is used across all of the strips in the batch. Furthermore, any variation in tooth geometry is limited by the shape and size of the machining tool. For example, the length of a repeated pattern of saw teeth is limited by the length of the milling tool used. It is therefore difficult to provide sufficient flexibility and complex patterns of tooth geometry that are desirable to provide efficient cutting or specialised toothed cutting tools.

In one aspect, the present invention provides a method of producing toothed blades from a strip material, the method comprising: cutting the strip material using combined laser cutting and mechanical machining or using waterjet cutting to form a plurality of teeth in an edge of the strip material, wherein the cutting is controlled to cut each of the teeth using a flexible programmable geometry.

By using laser or waterjet cutting where the cutting of the teeth is controlled using a flexible programmable geometry a more flexible shape or pattern of teeth can be efficiently produced. This is advantageous over existing milling techniques where flexibility of the saw tooth geometry is limited by the shape of the milling tool or the need to cut across batches of stacked strip material.

The present invention therefore provides a method of producing toothed blades in which the variability of the geometry is not constrained by the geometry of a cutting tool. This is advantageous over prior art methods in which the width of a grinding wheel or machine tool used to cut the teeth limits the varied geometry that can be achieved. By providing a flexible programmable geometry, the variability of the tooth geometry is unconstrained and can incorporate variations over a much greater distance along the length of the strip material in comparison to prior art grinding methods. Contrary to this, in prior art methods, only variations in geometry over a short, fixed length (e.g. over the length of a 150 mm grinding tool) can be provided.

Optionally, the flexible programmable geometry comprises varying the geometry of the plurality of teeth along the length of the strip material. This may provide increased flexibility of tooth geometry and improve cutting performance.

Optionally, the geometry is varied such that consecutive teeth along the length of the strip material have differing geometry. This may allow a balanced toothed blade to be produced.

Optionally, the geometry is varied such that groups of two or more consecutive teeth having different geometry to each other form a repeating pattern along the length of the strip material.

Optionally, at least one geometry parameter varies progressively between the two or more teeth forming the repeated pattern. This may allow continuously varied cutting pressure along the length of the resulting toothed blades.

Optionally, a first group of consecutive teeth have a first geometry and a second group of consecutive teeth have a different second geometry.

Optionally, the groups of teeth have a length of greater than about 150 mm along the length of the strip material, and wherein preferably the groups of teeth have a length of 500 mm or more along the length of the strip material. The method may therefore provide variation over lengths longer than provided by prior art grinding techniques.

Optionally, the programmable geometry comprises a varied geometry across the width of the strip material. This may provide further flexibility in shape of the teeth.

Optionally, the varied geometry across the width of the strip material comprises a non-perpendicular cut angle. This may allow the toothed blades to be sharpened at the same time as the teeth being cut.

Optionally, the cutting is controlled such that a first tooth of the plurality of teeth has a first cut angle and a second tooth of the plurality of teeth has a second cut angle, the first cut angle being different to the second cut angle. This may provide different angles of sharpening along the length of the strip material.

Optionally, the cutting is controlled such that either or both of the first and second cut angles comprise a cut angle that is angled away from perpendicular to a face of the strip material. This allows a sharpened point to be provided by the cut edge forming the teeth.

Optionally, the cutting is controlled such that the first cut angle is in an opposite direction to the second cut angle. This may allow left and right hand sharpening to be produced on the same length of strip material.

Optionally, the plurality of teeth comprises an equal number of teeth having the first cut angle compared to a number of teeth having the second cut angle. This may allow a balanced sharpening of the resulting toothed blade(s).

Optionally, the first and second teeth are arranged consecutively along the length of the strip material or wherein the first and second teeth are arranged to form a group of two or more consecutive first teeth and a group of two or more consecutive second teeth.

Optionally, the flexible programmable geometry comprises varying any one or more of the following tooth geometry parameters: a) tooth pitch; b) tooth gullet depth; c) tooth height; and d) tooth shape.

Optionally, the method further comprises setting an angle of one or more of the teeth, wherein the programmable geometry is controlled according to the set angle of the respective tooth. This may allow the set angle of the teeth to be optimised for the geometry of each tooth.

Optionally, the set angle is matched to a cut angle of the respective tooth such that the set angle of the respective tooth away from the face of the strip material corresponds to the cut angle away from perpendicular to the face of the strip material. This may help to accentuate the sharpening effect provided by the non-perpendicular cut angle once the teeth are set.

Optionally, the set angle is matched to a cut angle of the respective tooth such that the set angle of the respective tooth away from the face of the strip material opposes the cut angle of the respective tooth. This may reduce the cut angle once the teeth are set, thus increasing the contact between the cut edge and the material being cut.

Optionally, the laser cutting or waterjet cutting comprises cutting using one or more cutting heads having an adjustable cutting angle relative to the edge strip material; and/or wherein the laser cutting or waterjet cutting comprises cutting using a plurality of cutting heads each having a different fixed cutting angle relative to the edge of the strip material. This may allow the flexible programmable geometry to be produced.

Optionally, the strip material comprises a length from which multiple toothed blades can be produced. This may allow a large number of toothed blades to be more efficiently produced.

Optionally, each of the multiple toothed blades comprises a plurality of teeth such that each of the plurality of teeth has a unique geometry.

Optionally, the method further comprises mechanically machining the material strip to remove a cutting affected portion of the material resulting from the laser or waterjet cutting. This may allow any effect of the cutting to be quickly removed by a fast grinding process.

In another aspect, the present invention provides a toothed blade production line arranged to produce toothed blades from a strip material using the method of the first aspect, the production line comprising: a cutting apparatus comprising: i) a laser cutting apparatus arranged to cut a plurality of teeth into an edge of the strip material and a mechanical machining apparatus arranged to remove at least part of a heat-affected portion of the edge resulting from the laser cutting; or ii) a waterjet cutting apparatus arranged to cut a plurality of teeth into an edge of the strip material; and a controller arranged to control the cutting apparatus to cut each of the teeth using a flexible programmable geometry.

Optionally, the cutting apparatus is arranged to cut one or more continuous lengths of strip material.

Optionally, the toothed blade production line further comprises a guide means arranged to feed a continuous length of strip material into the cutting apparatus, wherein the guide means preferable comprises an input spool or coil and an output spool or coil.

Optionally, the toothed blade production line further comprises a mechanical machining apparatus arranged to remove at least part of a cutting affected portion of the edge of the strip material resulting from the waterjet cutting.

Optionally, the toothed blade production line further comprises a tooth setting apparatus arranged to set an angle of one or more of the plurality of teeth, wherein the flexible programmable geometry is controlled according to the set angle.

Optionally, the toothed blade production line further comprising a conveying mechanism, and optionally wherein the conveying mechanism comprises a guide means arranged to guide the length of strip material through a cutting region of the cutting apparatus, and preferably wherein the guide mechanism comprises an input roller arranged to guide the length of strip material into the cutting apparatus and an output roller arranged to guide the length of strip material out of the cutting apparatus.

Optionally, the conveying mechanism is further arranged to provide relative conveying movement between the strip material and the mechanical machining apparatus.

Optionally, the conveying mechanism is arranged to convey a continuous length of the strip material through both the waterjet cutting apparatus or the laser cutting apparatus and the mechanical machining apparatus.

Optionally, the production line further comprises either or both of: a) a feeder mechanism for feeding the strip material from an input spool, or coil, to the conveying mechanism; and b) an recoiling mechanism for recoiling the strip material onto an output spool.

Optionally, the toothed blade production line further comprises a dividing apparatus arranged to divide the strip material into multiple toothed blade lengths.

Optionally, the strip material comprises a length from which multiple toothed blades can be produced.

Embodiments of the invention will now be described, by way of example only, with reference to the accompanying drawings, in which:

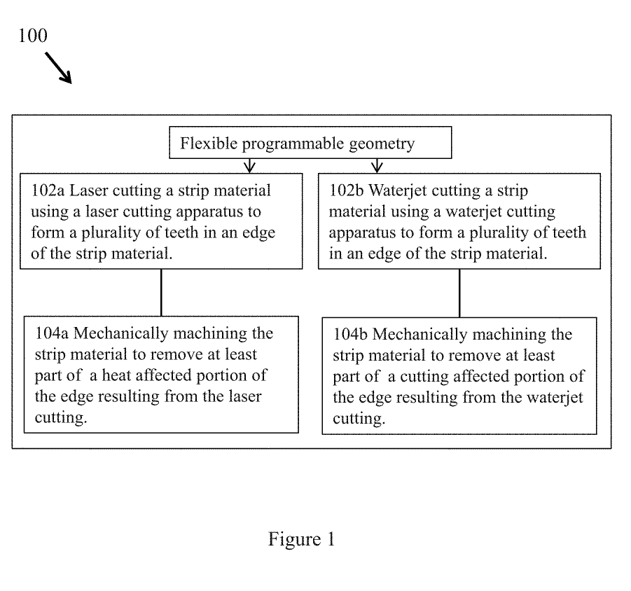

FIG. 1 is a representation of a method of producing toothed blades according to an embodiment;

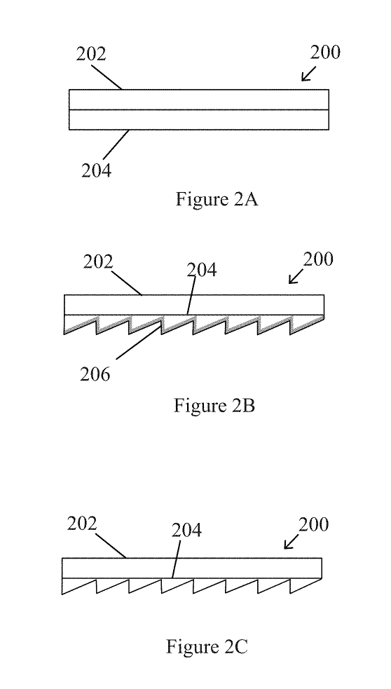

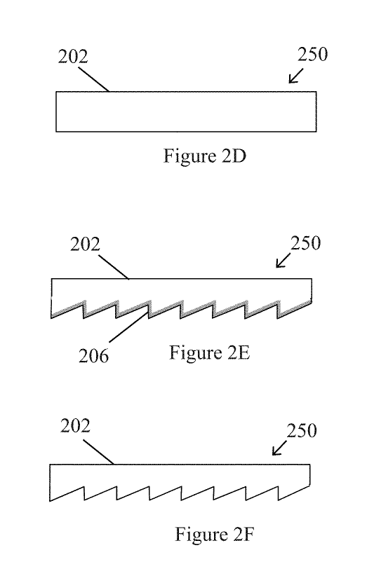

FIGS. 2A, 2B and 2C show close-up views of a section of bi-metal strip material at different stages during the method shown in FIG. 1;

FIGS. 2D, 2E and 2F show close up views of a non-composite strip material at different stages during the method shown in FIG. 1;

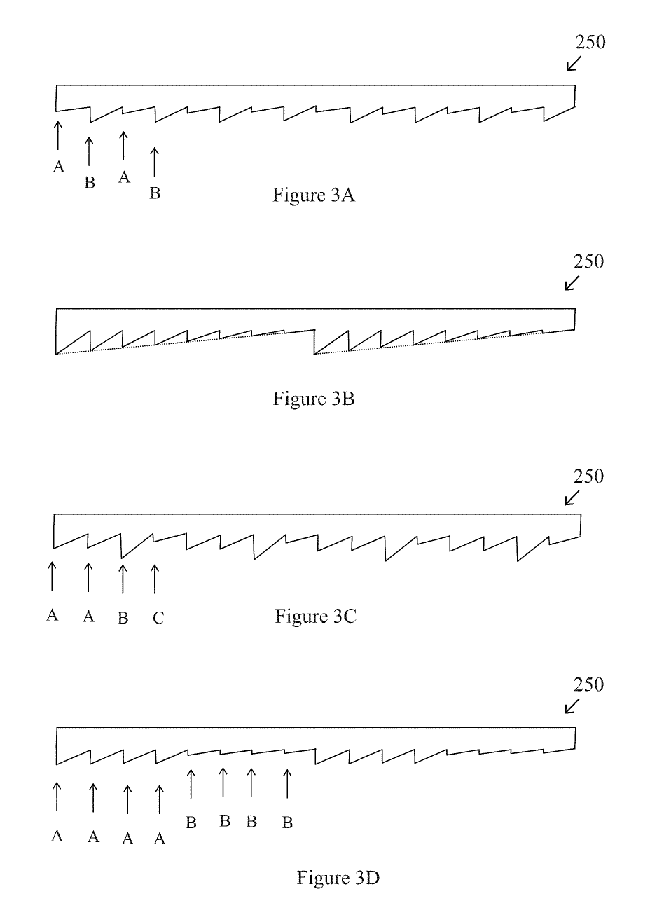

FIGS. 3A, 3B, 3C and 3D show examples of teeth cut according to the method shown in FIG. 1;

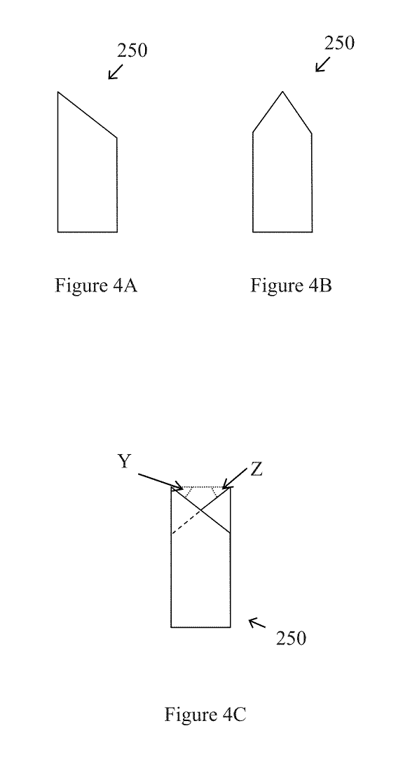

FIGS. 4A, 4B, 4C show other examples of teeth cut according to the method shown in FIG. 1;

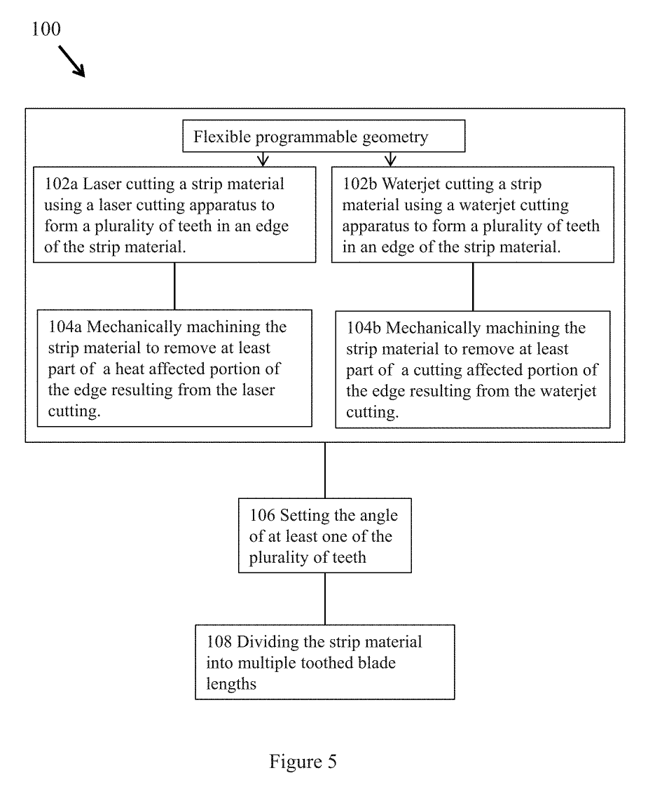

FIG. 5 is a representation of a method of producing toothed blades according to an embodiment;

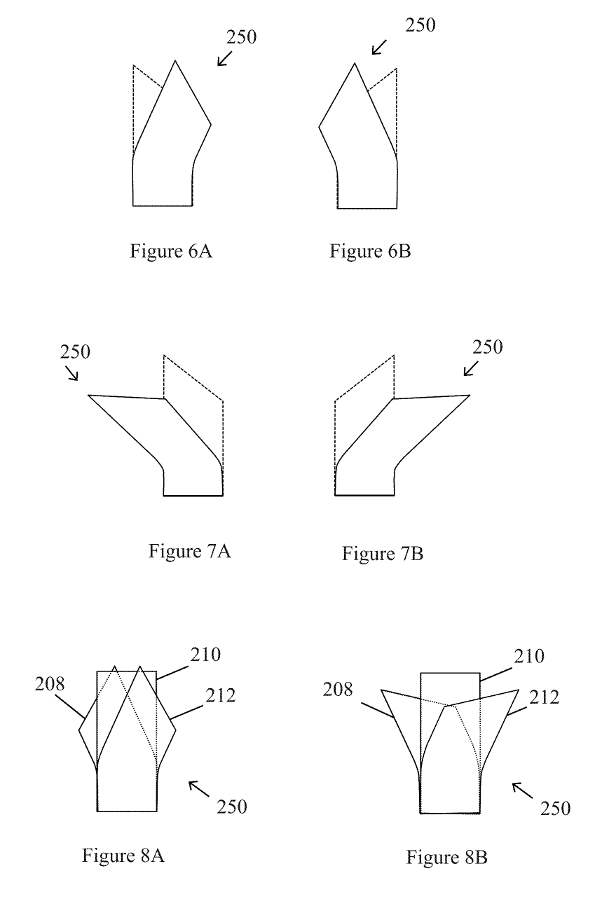

FIGS. 6A, 6B, 7A, 7B, 8a and 8b show examples of teeth cut and set according to the method shown in FIG. 5;

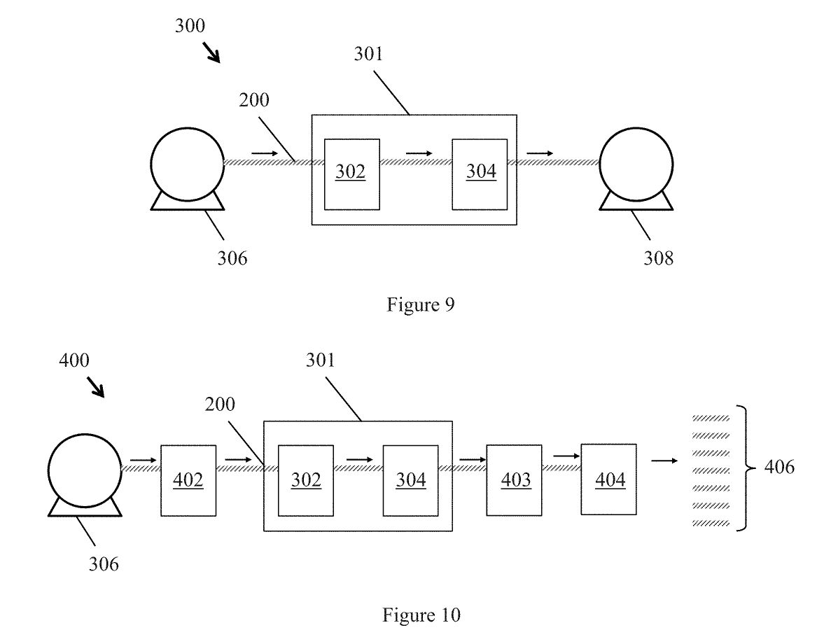

FIG. 9 shows a schematic representation of a toothed blade production line according to an embodiment; and

FIG. 10 shows a schematic representation of a toothed blade production line according to another embodiment.

A method 100 of producing toothed blades from a strip material is shown schematically in FIG. 1. The method 100 is suitable for producing toothed blades such as saw blades, including for example band-saw blades; hack saw blades; reciprocating saw blades; and holesaw blades. The method is however not limited to producing saw blades, but may also be used to manufacture other articles such as knives or other tools.

The toothed blades may be produced from a variety of materials. In some embodiments, the strip material comprises a metallic strip such as a steel strip. In some embodiments the strip material is formed from a bi-metal, carbon metal alloy or metal carbide strip material. A section of a bi-metal strip material 200 is shown schematically in FIGS. 2A, 2B and 2C at various stages of the method 100. FIGS. 2D, 2E and 2F represent non-composite strip 250 produced in the same manner. As can be seen in FIG. 2A, the bi-metal strip material 200 begins as a generally elongate strip formed from a first metal (or metal alloy) 202 and a second metal (or metal alloy) 204 joined together by welding or the like as is known in the art. The first and second metals 202, 204 may have differing properties to provide a saw blade having a suitable combination of cutting speed and durability.

In some embodiments, the first metal (or alloy) 202 may be harder than the second metal (or alloy) 204, and may for example, be formed of high speed steel. In such an embodiment, the teeth of the toothed blade may be formed from the first metal 202 so as to provide a hard material for cutting. As the second metal 204 is comparatively softer it may reduce the brittleness of the overall toothed blade. This may therefore provide an advantageous balance between fast cutting (using the relatively hard first metal 202) and durability (as the second relatively soft metal 204 is not as susceptible to cracking).

In other embodiments, the toothed blades may be produced from a metal strip made from a material other than a bi-metal. The toothed blades may, for example, be made from a metal strip material comprising a single metal, or any other number of metal, metals or alloys or other materials. FIGS. 2D, 2E and 2F show an embodiment in which a non-composite strip 250 is processed. In this embodiment, the strip material comprises a single material, such as a single metal 202.

The method 100 comprises cutting the strip material to form a plurality of teeth in an edge of the strip material. The cutting may be carried out using a combination of laser cutting 102a followed by a mechanical machining process 104a, or alternatively using waterjet cutting 102b followed by an optional mechanical machining process 104b.

For the laser cutting 102a, the teeth may be cut using a laser cutting apparatus arranged to direct laser radiation onto the surface of the strip material to cut the material via localised heating as is known in the art. The laser cutting apparatus may comprise a single cutting laser that is directed to the strip from a single direction (e.g. to cut from one surface of the strip material). In other embodiments, the laser cutting apparatus may comprise a first and a second laser arranged such that they oppose each other to cut from each surface of the strip material. This may reduce the burr produced by the laser cutting. In the described embodiment, a single edge of the strip material 200, 250 may be cut to form teeth. In other embodiments, any number of edges or parts of the strip material 200, 250 may be cut by the laser (or waterjet) cutting processes 102 to form the teeth.

During the cutting of the strip material a cutting affected portion 206 of the strip material is created. In the case of laser cutting, the cutting affected portion comprises a heat-affected portion (or heat-affected zone) of the strip material 200, 250 which is produced as a result of the heat required to cut the material. The heat-affected portion 206 is created by conduction of heat in the material away from and around the cutting point. Where the metal (or other material) forming the strip is heated a phase change can occur within the structure leading to undesirable properties. The heat affected-portion 206 may be formed adjacent or along the cut edge of the strip material 200, 250 as shown in FIGS. 2B and 2E.

In the case of laser cutting, the method 100 further comprises mechanically machining 104a the strip material 200, 250 to remove at least part of the heat-affected portion 206. In some embodiments, all of the heat-affected portion 206 may be removed by the mechanical machining. In other embodiments, only part of the heat-affected portion 206 is removed. In some embodiments, the mechanical machining step may remove both the heat-affected portion 206 and a part of the strip material not affected by the laser cutting step 102a. By providing a combination of both laser cutting and mechanical machining the method 100 allows the efficient production of a continuous length of toothed strip material.

The mechanical machining 104a, 104b may comprise any suitable method of machining the strip material 200, 250 to remove the required material. The mechanical machining 104a, 104b may comprise milling, grinding, drilling or any other suitable machining method. By mechanical machining we mean removing material using a cutting or grinding tool or the like as opposed to removal of material via laser cutting or the like.

Alternatively to the combined laser cutting 102a and mechanical machining 104a, the method may comprise waterjet cutting 102b the strip material to form a plurality of teeth in an edge of the strip material. The teeth may be cut using a waterjet cutting apparatus arranged to direct one or more waterjets onto the surface of the strip to cut the material via erosion. During the waterjet cutting 102b, a continuous length of the strip material may be conveyed relative to the waterjet cutting apparatus. In other words, a continuous length of material is conveyed through the waterjet (or jets) used to cut the material. The use of waterjet cutting in this way provides a fast production rate as a long length of material suitable to form a plurality of individual saw blades can be fed through the waterjet cutting apparatus.

By waterjet we mean a cutting jet formed by water only or by a mixture of water and other liquids or materials. For example, a mixture of water and an abrasive material (e.g. sand or garnet) may be used. In yet other embodiments, the water may be replaced with another suitable liquid.

The waterjet cutting apparatus may comprise a single cutting waterjet that is directed to the strip from a single direction (e.g. to cut from one surface of the strip material). In other embodiments, the waterjet cutting apparatus may comprise a first and a second waterjet arranged such that they cut at separate points along the length (or width) of the strip material (e.g. they may be arranged in a linear fashion along the surface of the strip material). This may increase the speed of the waterjet cutting. In the described embodiment, a single edge of the strip material 200, 250 may be cut to form teeth. In other embodiments, any number of edges or parts of the strip material 200, 250 may be cut by the waterjet cutting processes 102 to form the teeth.

In some embodiments, a single length of material strip may be cut by the laser or waterjet cutting apparatus. In such an embodiment, the laser or waterjet cutting apparatus may comprise one or more laser beams or waterjets directed to the same length of strip material. In other embodiments, the laser or waterjet cutting apparatus may be arranged to cut two or more lengths of strip material in parallel. In such an embodiment, one or more laser beams or waterjets may be directed to each separate length of strip material. This may further increase the rate of production. In yet other embodiments, a plurality of lengths of strip material stacked together may be cut by a single laser beam or waterjet (or group of laser beams or waterjets).

In some embodiments, the waterjet cutting 102b may also be combined with a mechanical machining step 104b equivalent to the mechanical machining step following the laser cutting. During the waterjet cutting 102b a rough or burred edge may be produced forming a cutting affected portion of the material. In other embodiments, other undesirable cutting affects may be produced in the material at or near the point of cutting. A mechanical machining step 104b may therefore be used after the waterjet cutting to remove some, or all, of the cutting affected portion 206. The mechanical machining step 104b may remove any undesired burr formed at the cut edge, and/or may produce a smooth cut surfaces. In other embodiments, the waterjet cutting may be controlled such that the mechanical machining step 104b is not required, either because the cutting affected portion is eliminated, or reduced to an acceptable level.

The cutting is controlled to cut each of the teeth using a flexible programmable geometry. The cutting may be controlled to provide a flexible geometry that can be varied across the length and/or width of the strip material during cutting. Each of the plurality of teeth cut into the strip material may therefore be provided with a tailored geometry, rather than all being cut with a perpendicular cut edge and/or common shape along the length of the strip material.

This provides improved flexibility in tooth pattern and design while maintaining high rates of production. An improved manufacturing method is provided compared to prior art milling and grinding techniques where flexibility in tooth geometry is limited by the cutting tool used or the need to cut multiple lengths of material simultaneously.

The laser cutting or waterjet cutting 102a, 102b may be controlled by a control signal received from a controller in communication with the laser or waterjet cutting apparatus. The control signal may comprise instructions to cause relative movement between the laser beam or waterjet and the strip material in order to achieve the flexible programmable geometry. In some embodiments, the control signal may comprise instructions to control any other parameter or parameters of the laser or waterjet cutting to control the geometry of the teeth being cut (e.g. the laser beam intensity or waterjet nozzle size, etc).

The controller may comprise a memory arranged to store one or more preset tooth geometries that can be selected by the user. In some embodiments, the controller may be arranged to receive a user input in order to define a desired tooth geometry (which may subsequently be stored in the memory). This may provide improved flexibility in the geometry that can be produced. The stored or received tooth geometries may comprise values of one or more geometry parameters defining the flexible programmable geometry (e.g. the tooth pitch, height, cut angle, etc. and how these vary along the length of the strip material.). The stored or received geometries may also include information about the set angle for the plurality of teeth as will be described later.

The mechanical machining step 104a, 104b may be performed using a cutting tool (e.g. a grinding wheel) arranged to move in two directions relative to the strip material. This may allow the position (e.g. lateral position) of the cutting tool to be varied according to the flexible programmable geometry of the plurality of teeth cut by the laser or waterjet cutting 102a, 102b. A heat affected or cutting affect portion of the strip material may therefore be removed while retaining the flexible programmable geometry provided by the laser or waterjet cutting 102a, 102b. The combination of laser/waterjet cutting and mechanical machining of the described embodiment may allow a wide varied of tooth geometries to be provided, with a high rate of production, compared to using prior art mechanical machining alone.

In some embodiments, the mechanical machining step 104a, 104b provided following the laser cutting or waterjet cutting 102a, 102b may be also be controlled by the controller. In such an embodiment, the controller may be arranged to provide a control signal to the mechanical machining apparatus to control the mechanical machining to coincide with the tooth geometry already cut by the laser or water jet cutting steps.

In other embodiments, a separate laser/waterjet cutting controller and mechanical machining controller may be provided. In this embodiment, the laser/waterjet cutting controller may be arranged to provide a control signal to the mechanical machining controller to control the mechanical machining according to the flexible programmable geometry.

In some embodiments, the mechanical machining controller may be arranged to determine the tooth geometry directly from the strip material which has already been cut by the laser or waterjet cutting. The mechanical machining controller may, for example, receive an input from an imaging device (e.g. a camera or the like) arranged to image the strip material. The controller may be arranged to determine the geometry of the teeth already cut by the laser or waterjet cutting from received images of the strip material and determine the geometry of mechanical machining required.

In other embodiments, a readable indicator may be provided on the strip material (e.g. a barcode or QR code or the like) which may store information relating to the flexible programmable geometry of teeth desired. The information stored by the indicator may be obtained by the controller (or by either or both the laser/waterjet cutting controller and mechanical machining controller) to determine the desired geometry and control the laser/waterjet cutting and/or the mechanical machining accordingly. The indicator may store preset values of one or more geometry parameters defining the flexible programmable geometry (e.g. the tooth pitch, height, cut angle, etc.). In other embodiments, the indicator may store a reference ID corresponding to a preset geometry stored in the controller memory as described above.

The flexible programmable geometry may take a number of different forms and may produce a number of different tooth shapes and patterns of tooth shapes. Controlling the geometry of the teeth may comprise controlling any one or more of a number of tooth geometry parameters that define the shape of each of the plurality of teeth. The tooth geometry parameters may include: the tooth pitch; the tooth depth; the tooth height and the cut angle (e.g. the angle of the cut edge relative to the surface being cut i.e. the side face of the resulting toothed blade(s)).

In some embodiments, the flexible programmable geometry comprises varying the geometry of the plurality of teeth along the length of the strip material. This means that the geometry of the plurality of teeth is not the same for each tooth along the length of the strip. However, some of the plurality of teeth may have the same geometry as each other—they are not necessarily all different from each other and may form a repeating pattern, as will be described in more detail later. In some embodiments, each of the plurality of teeth may have a unique geometry (e.g. there is no repeating pattern of geometry variation amongst the plurality of teeth).

Some examples of possible varied tooth geometries along the length of the strip material are shown in FIGS. 3A to 3D. These examples are shown for a strip material made from a single material 250 (e.g. that shown in FIG. 2D), but could equally apply to the bimetallic strip shown in FIG. 2A, or any other suitable strip materials.

In some embodiments, the geometry is varied such that consecutive teeth along the length of the strip material 250 have a differing geometry. An example of this can be seen in FIG. 3A, where consecutive teeth alternate between a first geometry A and a second geometry B (only the first four teeth are labelled in FIG. 3A for clarity). In this example, the geometry is varied by altering the tooth height between consecutive teeth. In other embodiments, any other (or more than one) geometry parameter may be altered between consecutive teeth along the length of the strip material. For example, the cut angle can be varied between alternate teeth as will be described later.

In other embodiments, the geometry is varied such that groups of two or more consecutive teeth having different geometry to each other form a repeating pattern along the length of the strip material. In some embodiments, at least one geometry parameter may vary progressively between the two or more teeth forming the repeated pattern. An example of this is shown in FIG. 3B, where the tooth height varies progressively from a large tooth height at the first tooth of the group to a small tooth height at the last tooth of the group. In this example, the tooth height varies progressively between teeth forming the repeated group, whereas in other embodiments one or more other parameters may vary progressively, such that the tooth pitch or spacing.

The progressive change in geometry may be a decrease in a geometry parameter across the teeth forming the repeated group as shown in FIG. 3B. In other embodiments, the geometry parameter may increase across the repeated group, or may progressively increase and then decrease, or vice versa. Furthermore, the number of teeth forming the repeated group in FIG. 3B is just one example. In other embodiments, the repeated group may be formed by any number of teeth. In some embodiments, the progressive variation in tooth geometry may extend along the full length of the strip material such that no repeated geometry is formed.

Patterns of varying tooth geometry over a longer length pattern provided by the method 100 can set up a revolving motion in the cutting process of resulting toothed blade(s). This may provide a change in saw pressure that allows material to clear from the cut area and may provide a better cutting action and may reduce harmonic vibrations. This wave motion of cutting has previously been attempted by cutting the wave profile into the side face of a completed saw blade. The ability to create a longer pattern of varying geometry allows a similar effect to be produced by building the effect into the tooth pattern, rather than having to use additional profiling of the strip material surface.

In other embodiments, the teeth forming the repeated group may vary in any other suitable pattern. For example, they may not vary progressively along the length of the strip material as shown in FIG. 3B, but may form a pattern of any other repeated changes in geometry. For example, in FIG. 3C a repeated group of teeth is formed where a first tooth has geometry A, a second tooth has geometry A, a third tooth has geometry B and a fourth tooth has geometry C. This pattern is then repeated along the length of the strip material. Again, this is only one example of the possible variation between teeth that can be provided in a repeated group.

In other embodiments, the group of consecutive teeth forming the first group may have a first geometry and the group of consecutive teeth forming the second group may have a different second geometry to form a repeating pattern. An example of this is shown in FIG. 3D. In this example, a first group of four consecutive teeth are shown having a first geometry A, and a second group of consecutive teeth are shown having a second geometry B. The first and second groups may then be repeated to form a repeating pattern along the length of the strip material. In the example shown in FIG. 3D, the height of the teeth may be different between the first and second groups. In other embodiments, any one or more of the other geometry parameters mentioned above may be varied between groups. FIG. 3D shows only one example—in other embodiments the first and second group may have any number of teeth, and may have the same or differing number of teeth to each other.

The repeating pattern formed by groups of teeth is advantageously not limited by the size and shape of a physical machining tool used to shape the teeth if they were to be only ground or milled. The pattern of repeating groups of teeth may be varied over any distance. The length of the repeated pattern may have a length of greater than about 150 mm along the length of the strip material, for example. This provides a long length of repeat that is difficult to achieve with prior art techniques. Preferably, the repeating pattern may have a length of about 400 mm, 500 mm, 600 mm, 800 mm, 1000 mm or more or any range in between those values.

The variation of geometry is not therefore limited by the physical constraints of a cutting tool as with prior art techniques. Using such techniques, variations in geometry are only provided over the width of a grinding wheel or machining tool e.g. 150 mm or less. The method 100 allows an unconstrained geometry that can be set according to the design considerations of the toothed blades being produced. This allows greater flexibility in geometry variation, including variation over a much longer distance along the length of the toothed blades in comparison to prior art methods. The method 100 therefore allows flexible and varied geometries to be produced efficiently for toothed blades produced in large numbers.

In other embodiments, the programmable geometry may comprise a varying geometry across the width of the strip material. The shape of the tooth therefore may vary through the thickness or width of the strip material such that the shape of the tooth is different on one side of the strip material compared to the other.

Examples of varying the geometry across the width of the strip material are shown in FIGS. 4A and 4B. These examples again show cutting of strip material formed from a single material 250, but could equally apply to bi-metallic strip material 200. The geometry across the width of each tooth may be varied such that a non-perpendicular cut angle is formed as shown in the example of FIG. 4A, which shows a cross section through the strip material. FIG. 4A is however only one example of forming a varied geometry across the width of the tooth. In other embodiments, a more complex varied geometry may be created as shown in FIG. 4B, which shows an example of two oppositely angles surfaces being formed at the cut edge. In yet other embodiments, more complex geometries may be provided including further numbers of flat cut surfaces or curved cut edges to provide a rounded edge to the strip material.

The method of cutting 100 may therefore provide improved flexibility of geometry across the width of the tooth compared to prior art methods which usually form a perpendicular cut. The geometry may be varied across the width of the plurality of teeth to form a sharpened cutting edge. By varying the cutting in this way, the teeth can be sharpened at the same time as being cut into the edge of the strip material, therefore providing a quicker more efficient production method. In prior art methods, a separate sharpening process may be required after teeth have been milled or ground into the edge of the teeth to provide a sharpened edge.

In some embodiments, the varied geometry across the width of the teeth may be the same for all of the plurality of teeth. In such an embodiment, the plurality of teeth may each have the same geometry across the width of the tooth—e.g. they may all be cut at the same non-perpendicular cut angle. This may provide an unbalanced sharpening of the resulting toothed blade(s) which may cause a lateral force during cutting. For some types of toothed blade this may be desirable, or may not be problematic. For example, if the toothed blade is formed into a holesaw, a balanced radial force may be provided despite the teeth all having the same cut angle.

In some embodiments, the varying geometry across the width of the teeth may be combined with the varied geometry along the length of the strip material.

For example, the waterjet or laser cutting may be controlled such that a first tooth of the plurality of teeth has a first cut angle Y and a second tooth of the plurality of teeth has a second cut angle Z (as labelled in FIG. 4C), the first cut angle being different to the second cut angle. This means that different teeth along the length of the strip material may have a different geometry across the width of the material (e.g. they are cut at a different angle). In some embodiments, either or both of the first and second cut angles comprise a cut angle that is angled away from perpendicular to a face of the strip material. In other embodiments, the first cut angle may be angled away from perpendicular, whereas the second cut angle may be perpendicular. This may allow the sharpening of the teeth to be varied along the length of the strip material.

In some embodiments the laser cutting or waterjet cutting may be controlled such that the first cut angle is in an opposite direction to the second cut angle. The cut angles may therefore be to the same amount away from perpendicular, but may be in opposite directions as shown in FIG. 4C. This may allow left and right sharpened teeth to be created along the length of the strip material. In some embodiments, the first and second teeth are arranged consecutively along the length of the strip material so that the cut angle of the plurality of teeth may alternative between a left-hand sharpening and right-hand sharpening. In other embodiments, the first and second teeth are arranged to form a group or groups of consecutive first teeth and a group or groups of consecutive second teeth rather than alternating consecutively.

By providing teeth cut with equal, but opposite, angles from perpendicular a more balanced sharpened toothed blade can be produced. This may help reduce or eliminate lateral forces during cutting. In some embodiments, the plurality of teeth may comprise an equal number of teeth having the first cut angle compared to a number of teeth having the second cut angle (e.g. an equal number of teeth having a left-hand sharpening compared to a right-hand sharpening). This may reduce or eliminate lateral forces during cutting. The method 100 may therefore provide sufficient cutting flexibility to not only provide sharpened teeth without a separate sharpening process, but may also at the same time provide a flexible degree of sharpening along the length of the strip material. This may allow the balance of the sharpened teeth of the resulting toothed blades to be controlled or optimised as desired.

Another embodiment of the method 100 is shown in FIG. 6. In this embodiment, the method 100 may further comprise setting 106 an angle of one or more of the teeth. In this embodiment, the programmable geometry is controlled according to the set angle of the respective tooth. The tooth setting may be carried out by a separate tooth setting step performed after the teeth have been cut into the edge of the strip material (e.g. after the laser cutting/water jet cutting and mechanical machining if required). The tooth setting may be carried out by bending or angling the teeth away from the body of the strip material as is known in the art. The setting step may be carried out by mechanically pushing the teeth away from parallel alignment with the body of the strip material.

In some embodiments, the tooth set may be varied along the length of the strip material. The set angle may, for example, be alternated between teeth, or may form more complex repeating patterns of differing set angle. In other embodiments, the plurality of teeth cut into the strip material may all have the same set angle.

The programmable geometry described above may be controlled according to the set angle of the respective tooth (or vice versa). The geometry of each of the plurality of teeth may therefore be tailored according to the setting angle which is formed in the subsequent setting step 106. By varying the geometry in this way, the geometry of the teeth may be optimised according to the set angle. In some embodiments, a tooth setting apparatus arranged to set an angle of the one or more teeth may be at least partly controlled by a control signal received from the controller (or separate laser/waterjet cutting controller). This may allow the tooth set angle to be varied according to the tooth geometry already cut.

In one embodiment, the set angle may be matched to the cut angle of the respective tooth. The set angle of the respective tooth away from the face of the strip material may therefore correspond to the cut angle away from perpendicular to the face of the strip material. The angle of the cut edge to perpendicular may therefore be increased by the setting of the tooth. An example of this is shown in FIGS. 6A and 6B. This may help to accentuate the sharpened edge formed by the varied geometry across the width of the strip material. The ability to cut a sharper tooth shape is significant since a sharper tooth will penetrate the substance being cut more quickly and will give an improved cutting performance. Different angles of saw tooth sharpness can be used to create toothed blades designed to penetrate the cutting material more quickly.

In other embodiments, the set angle is matched to a cut angle of the respective tooth such that the set angle of the respective tooth away from the face of the strip material opposes the cut angle of the respective tooth. An example of this is shown in FIGS. 7A and 7B. In this example, the setting of the tooth is matched to the cut angle so that the resulting angle of the cut edge to perpendicular is decreased when the tooth is set. The resulting cut edge may be arranged such that it is perpendicular to the face of the strip material. The cut angle may therefore be chosen to compensate for the set angle applied to the respective tooth. This may result in a toothed blade which, once set, still has a cutting surface at 90 degrees to the direction of cut. This may provide a toothed blade without a sharpened point—but which may have a wider cutting contact and reduced point wearing. This may therefore provide a smoother, more consistent and longer lasting cut.

The tooth setting along the length of the strip material and the varied geometry along the width and length of the strip material may be varied at the same to provide complex patterns of tooth geometry. An example of this is shown in FIGS. 8a and 8b which show cross sections through the strip material once the teeth have been cut and set. In the embodiment shown in FIG. 8A, a left-hand sharpened and set tooth 208 is followed by an unset and unsharpened tooth 210 which is followed by a right-hand sharpened and set tooth 212. In this embodiment, the cut angle corresponds to the set angle to accentuate the tooth sharpening as shown in the examples of FIGS. 6A and 6B (e.g. it slopes away from the body of the strip material). In FIG. 8B, the angle of cut for the set and sharpened teeth 208 and 212 is in the opposite direction, e.g. sloping towards the body of the strip material. The arrangement shown in FIG. 8b may tend to push the teeth outwards when cutting, thus maintaining a good saw “set” (e.g. maintaining the angle of the teeth from the body of the strip material) and kerf (i.e. the thickness of the cut).

In the embodiment shown in FIG. 6, the method 100 may further comprise dividing 108 the strip material 200, 250 into multiple toothed blade lengths following the mechanical machining step 104 (and the teeth setting step 106 if included). This may be done by cutting the strip material using any suitable method known in the art. The strip material may therefore comprise a length from which multiple toothed blades can be produced once it has been divided. In other embodiments, the strip material 200 may be wound around an output spool after the mechanical machining 104 to be used in a single length or divided into individual toothed blades in a separate process. The strip material may be divided according to the varied geometry such that toothed blades have different tooth geometry to each other may be produced.

In order to produce the varied geometry across the width of the strip material, the laser cutting 102a or waterjet cutting 102b may comprises cutting using one or more cutting heads having an adjustable cutting angle relative to the edge of strip material (e.g. 5 axis adjustable cutting heads). In other embodiments, the laser cutting or waterjet cutting may comprise cutting using a plurality of cutting heads each having a different fixed cutting angle relative to the edge of the strip material.

A tooth blade production 300 line arranged to produce toothed blades from a strip material using the method described above is shown schematically in FIG. 9. The production line comprises a cutting apparatus 301, which comprises: a laser cutting apparatus or a waterjet cutter apparatus (both labelled 302 in the Figures) arranged to cut a plurality of teeth into an edge of the strip material. The cutting apparatus further comprises a mechanical machining apparatus 304 arranged to remove at least part of a heat-affected portion or a cutting affected portion of the edge resulting from the laser or waterjet cutting respectively. In some embodiments, the mechanical machining apparatus may not be required where cutting is done by the waterjet cutting apparatus as described above.

The production line 300 further comprises a controller arranged to control the cutting apparatus to cut each of the teeth using a flexible programmable geometry as described above. The controller may be arranged to adjust the cutting geometry as the strip material is fed through the cutting apparatus 301. This may allow the flexible programmable geometry describe above to be created.

The laser or waterjet cutting apparatus 302 is arranged to cut a plurality of teeth into an edge of the strip material 200, 250 as described above. The laser or waterjet cutting apparatus 302 may comprise a laser or waterjet cutting station having at least one laser beam or waterjet arranged to cut teeth into an edge of the strip material 200. In some embodiments, the laser or waterjet cutting apparatus may comprise one or more laser beams or waterjets arranged in series on the same strip of material, while in other arrangements two or more single laser beams or waterjets (or groups of laser beams or waterjets) may be arranged to cut two or more separate strips of material in parallel. This may allow a faster rate of cutting using the same waterjet cutting apparatus.

The laser or waterjet cutting apparatus 302 may be arranged to provide relative movement between the one or more laser beams or waterjets and the strip material 200, 250 such that the programmable tooth geometry may be cut. The relative movement may be controlled by inputs from the controller to form the flexible programmable geometry described above. This may be done by moving the laser beams or waterjets (e.g. by moving a laser beam or waterjet cutting head) relative to the strip material 200, 250 (e.g. both of the strip material and the laser beam/waterjet may move). In other embodiments, the relative movement may be provided by moving the strip material 200, 250 relative to a stationary laser beam(s) or waterjet(s) (or laser/waterjet cutting head). The strip material 200, 250 may be moved relative to the laser beam or waterjet (or laser/waterjet cutting head) in a direction along the length of the strip material. The laser beams or waterjets may also be moved in a direction perpendicular to the length of the strip to provide the necessary directions of relative movement to a flexible programmable geometry of teeth.

The relative movement between the strip material and laser beam or waterjet may include an adjustable cutting angle relative to the edge of the strip material. The controller may therefore be arranged to varying the angle of the laser beam or waterjet during cutting to provide a varied geometry across the width of the strip material. In other embodiments, the laser cutting or waterjet cutting may comprise cutting using a plurality of cutting heads each having a different fixed cutting angle relative to the edge of the strip material.

The toothed blade production line 300 further comprises a conveying mechanism (not shown in the Figures) arranged to provide relative conveying movement between the strip material 200 and the laser or waterjet cutting apparatus 302. The conveying mechanism may also provide relative movement between the strip material 200 and the mechanical machining apparatus 304 where provided.

In some embodiments, the waterjet or laser cutting apparatus may comprise a support surface (e.g. a cutting bed) on which the strip material (or series of parallel lengths of strip material) may be supported during the application of the laser beam or waterjet.

The conveying mechanism may be arranged to align the strip material as it is conveyed through a cutting zone in which the waterjet or laser beam is applied. The conveying mechanism may be arranged to hold the strip material in a flat position relative to the support surface during cutting. In such an embodiment, the conveying mechanism may comprise an input roller arranged to direct the strip material into the cutting apparatus, an output roller to direct the cut strip material out of the cutting apparatus, and one or more alignment rollers arranged to align the strip material for cutting.

The conveying mechanism may be arranged to convey a continuous length of the strip material over the support surface so that continuous cutting of a length of the strip material can be achieved. The length of cut strip material can later be divided into a plurality of saw blades as needed. This may therefore provide an efficient, continuous production process in comparison to prior art batch cutting techniques.

In some embodiments, a single continuous length of strip material may therefore be conveyed through the cutting apparatus. In such an embodiment, the laser or waterjet cutting apparatus may comprise a single cutting laser beam or waterjet (or group of laser beams or waterjets) that is directed to the material strip. In other embodiments, two or more continuous lengths of strip material may be conveyed through the cutting apparatus. This may allow for parallel production to improve the rate of production by allowing simultaneous cutting of lengths of material. In such an embodiment, the waterjet cutting apparatus may comprise two or more separate laser beams or waterjets (or groups of laser beams and waterjets) arranged to cut each length of strip material as it travels through the cutting apparatus. In yet other embodiments, one or more laser beams or waterjets may be arranged to cut a plurality of lengths of strip material conveyed in a stacked configuration (e.g. the parallel lengths of strip material may be stacked to form a pack). This may allow the cutting of a number of lengths of strip material at the same time without the need for parallel cutting heads.

The conveying mechanism may be arranged to convey the strip material 200, 250 along a processing path through the production line 300. The conveying mechanism may therefore be arranged to convey the strip material 200, 250 through both the laser or waterjet cutting apparatus 402 and the mechanical machining apparatus 404 (where it is provided), and through any other components of the production line (e.g. a heat treatment apparatus, tooth-setting apparatus, and a dividing apparatus if provided).

The conveying mechanism may comprise one or more rollers arranged to support the strip material 200, 250 along its length along the processing path. In some embodiments, one or more of the rollers may be driven to move the strip material 200, 250 along the processing path.

The production line 400 may further comprise a feeder mechanism 306 for feeding (either directly or indirectly) the strip material 200, 250 from a spool, or coil, to the cutting apparatus 301. An output spool or coil 308 may also be provided on which the finished toothed strip material 200, 250 may be coiled.

Another embodiment of a toothed blade production line 400 is shown in FIG. 10. The production line 400 shown in FIG. 10 also comprises the cutting apparatus 301 (including the laser or waterjet cutting apparatus 302 and the mechanical machining apparatus 304). Any of the features described herein may be used in either the production line 300 shown in FIG. 9 or the production line 400 shown in FIG. 10.

As shown in FIG. 10, the production line 400 further comprises a heat treatment apparatus 402. The heat treatment apparatus 402 may comprise a furnace or induction heating device or the like. The heat treatment apparatus may be arranged to heat the strip material 200, 250 to a temperature suitable to harden the metal from which it is formed. The heat treatment apparatus 402 may be arranged to heat treat the strip material 200, 250 before it is cut by the cutting apparatus 301.

In the described embodiment, the heat treatment apparatus 402 may be arranged such that it precedes the laser or waterjet cutting apparatus 302 along the processing path followed by the strip material 200. The strip material 200 may therefore pass through the heat treatment apparatus 402 before reaching the laser or waterjet cutting apparatus 302.

The toothed blade production line 400 may further comprise a tooth setting apparatus 403 to perform the tooth setting as described above. The tooth setting apparatus may be arranged to angle at least one, or a plurality of, the teeth once they have been cut as described above. The tooth setting apparatus may be controlled by the controller so that the tooth setting can be tailored to the geometry of each specific tooth as described above.

The toothed blade production line 400 may further comprise a dividing apparatus 404 arranged to divide the strip material 200 into multiple toothed blade lengths 406. The dividing apparatus 404 may be arranged to receive the strip material 200 from the tooth-setting apparatus 403 (or the mechanical machining apparatus if the tooth setting apparatus is not provided, or from the cutting apparatus if the mechanical machining apparatus is not provided) and therefore after removal of the cutting affected portion and setting of the individual teeth.

The dividing apparatus 404 may comprises a cutting tool or the like suitable for dividing the strip material 200 into individual lengths. In other embodiments, the dividing apparatus 404 may comprise any device suitable for dividing the strip material 200, such as a grinding tool, milling tool or cutting torch.

The strip material 200 may therefore comprise a length from which multiple individual toothed blades can be produced. The toothed blade production line may, for example be arranged to process a single length of strip material 200, which may for example have a length restricted only by dimensional, or weight limitation, of the conveying mechanism to produce a plurality of individual saw blades 406.

The dividing apparatus may be arranged to divide the strip material according to the varied geometry creating by the laser or waterjet cutting apparatus 302. Individual toothed blades may therefore be produced having different tooth geometries to each other by cutting a single length of strip material.

In some embodiments, the method of producing a toothed blade may further comprise attaching a cutting tip to one or more of the plurality of teeth. The cutting tip may be welded onto the strip material at one or each of the teeth to provide a cutting surface. The cutting tip may comprise a carbide tip, hi-speed steel tip or any other metallic tip. The method may further comprise mechanically shaping (grinding or milling) the cutting tip to provide a final tip. This grinding process may be deeper than the mechanical grinding to remove the cutting affected portion (e.g. roughness or burr) resulting from the waterjet cutting of the tooth profile. The light mechanical machining step may still be needed across the profile of the saw tooth, in addition to the deeper mechanical shaping of the welded metallic tip and they may be provided in separate machining processes. In some embodiments, a tooth tipping apparatus may be provided to weld a tip to the teeth once the cutting affected portion has been removed. The teeth tipping apparatus may further comprise a second mechanical machining apparatus to shape the tipped teeth.

1. A method of producing toothed blades from a strip material, the method comprising:
cutting the strip material using combined laser cutting and mechanical machining or using waterjet cutting to form a plurality of teeth in an edge of the strip material, wherein the cutting is controlled to cut each of the teeth using a flexible programmable geometry.

2. A method according to claim 1, wherein the flexible programmable geometry comprises varying the geometry of the plurality of teeth along the length of the strip material.

3. A method according to claim 2, wherein the geometry is varied such that consecutive teeth along the length of the strip material have differing geometry.

4. A method according to claim 2, wherein the geometry is varied such that groups of two or more consecutive teeth having different geometry to each other form a repeating pattern along the length of the strip material and optionally wherein at least one geometry parameter varies progressively between the two or more teeth forming the repeated pattern.

5. (canceled)

6. A method according to claim 2, wherein a first group of consecutive teeth have a first geometry and a second group of consecutive teeth have a different second geometry.

7. A method according to claim 4, wherein the groups of teeth have a length of greater than about 150 mm along the length of the strip material, and wherein preferably the groups of teeth have a length of 500 mm or more along the length of the strip material.

8. A method according to claim 1, wherein the programmable geometry comprises a varied geometry across the width of the strip material.

9. A method according to claim 8, wherein the varied geometry across the width of the strip material comprises a non-perpendicular cut angle.

10. A method according to claim 1, wherein the cutting is controlled such that a first tooth of the plurality of teeth has a first cut angle and a second tooth of the plurality of teeth has a second cut angle, the first cut angle being different to the second cut angle.

11. A method according to claim 10, wherein any one or more of:
(a) the cutting is controlled such that either or both of the first and second cut angles comprise a cut angle that is angled away from perpendicular to a face of the strip material;
(b) the cutting is controlled such that the first cut angle is in an opposite direction to the second cut angle;
(c) the plurality of teeth comprises an equal number of teeth having the first cut angle compared to a number of teeth having the second cut angle;
(d) the first and second teeth are arranged consecutively along the length of the strip material or wherein the first and second teeth are arranged to form a group of consecutive first teeth and a group of consecutive second teeth.

12. (canceled)

13. (canceled)

14. (canceled)

15. A method according to claim 1, wherein the flexible programmable geometry comprises varying any one or more of the following tooth geometry parameters:
a) tooth pitch;
b) tooth gullet depth;
c) tooth height; and
d) tooth shape.

16. A method according to claim 1, further comprising setting an angle of one or more of the teeth, wherein the programmable geometry is controlled according to the set angle of the respective tooth.

17. A method according to claim 16, wherein:
(a) the set angle is matched to a cut angle of the respective tooth such that the set angle of the respective tooth away from the face of the strip material corresponds to the cut angle away from perpendicular to the face of the strip material; or
(b) the set angle is matched to a cut angle of the respective tooth such that the set angle of the respective tooth away from the face of the strip material opposes the cut angle of the respective tooth.

18. (canceled)

19. A method according to claim 9, wherein the laser cutting or waterjet cutting comprises cutting using one or more cutting heads having an adjustable cutting angle relative to the edge strip material; and/or
wherein the laser cutting or waterjet cutting comprises cutting using a plurality of cutting heads each having a different fixed cutting angle relative to the edge of the strip material.

20. A method according to claim 1, wherein one or both of:
(a) the strip material comprises a length from which multiple toothed blades can be produced and optionally each of the multiple toothed blades comprises a plurality of teeth such that each of the plurality of teeth has a unique geometry; or
(b) the method further comprises mechanically machining the material strip to remove a heat affected or cutting affected portion of the material resulting from the laser or waterjet cutting.

21. (canceled)

22. (canceled)

23. A toothed blade production line arranged to produce toothed blades from a strip material using the method of any preceding claim, the production line comprising:
a cutting apparatus comprising:
i) a laser cutting apparatus arranged to cut a plurality of teeth into an edge of the strip material and a mechanical machining apparatus arranged to remove at least part of a heat-affected portion of the edge resulting from the laser cutting; or
ii) a waterjet cutting apparatus arranged to cut a plurality of teeth into an edge of the strip material; and
a controller arranged to control the cutting apparatus to cut each of the teeth using a flexible programmable geometry.

24. A toothed blade production line according to claim 23, wherein the cutting apparatus is arranged to cut one or more continuous lengths of strip material.

25. A toothed blade production line according to claim 24, wherein any one or more of:
(a) the production line further comprises a guide means arranged to feed a continuous length of strip material into the cutting apparatus, wherein the guide means preferable comprises an input spool or coil and an output spool or coil;
(b) the production line further comprises a mechanical machining apparatus arranged to remove at least part of a cutting affected portion of the edge of the strip material resulting from the waterjet cutting;
(c) the production line further comprises a tooth setting apparatus arranged to set an angle of one or more of the plurality of teeth, wherein the flexible programmable geometry is controlled according to the set angle;
(d) the production line further comprises a dividing apparatus arranged to divide the strip material into multiple toothed blade lengths; or
e) the strip material comprises a length from which multiple toothed blades can be produced.

26. (canceled)

27. (canceled)

28. A toothed blade production line according to claim 23, further comprising a conveying mechanism, and optionally one or both of:
(a) the conveying mechanism comprises a guide means arranged to guide the length of strip material through a cutting region of the cutting apparatus, and preferably wherein the guide mechanism comprises an input roller arranged to guide the length of strip material into the cutting apparatus and an output roller arranged to guide the length of strip material out of the cutting apparatus; or
(b) the production line further comprises a feeder mechanism for feeding the strip material from an input spool, or coil, to the conveying mechanism; and/or the production line further comprises a recoiling mechanism for recoiling the strip material onto an output spool.

29. A toothed blade production line according to claim 23, further comprising a conveying mechanism, wherein the conveying mechanism is further arranged to provide relative conveying movement between the strip material and the mechanical machining apparatus and optionally the conveying mechanism is arranged to convey a continuous length of the strip material through both the waterjet cutting apparatus or the laser cutting apparatus and the mechanical machining apparatus

30.-33. (canceled)
